(19) United States
(12) Patent Application Publication
(10) Pub. No.: US 2026/0298670 A1
(43) Pub. Date: Oct. 1, 2026

(54) DIFFERENTIAL ANGLE POSITION SENSING USING INDUCTIVE POSITION SENSORS

(71) Applicant: Microchip Technology Incorporated, Chandler, AZ (US)

(72) Inventors: Ganesh Shaga, Warangal (IN); Surendra Akkina, Hyderabad (IN); Sudheer Puttapudi, Hyderabad (IN)

(73) Assignee: Microchip Technology Incorporated, Chandler, AZ (US)

(21) Appl. No.: 19/265,147

(22) Filed: Jul. 10, 2025

(30) Foreign Application Priority Data
Mar. 28, 2025 (IN) 202511030223

(51) Int. Cl. G01D 5/22

(52) U.S. Cl. CPC G01D 5/2275

(57) ABSTRACT

Systems and apparatuses include a first rotatable target having a first sensor and associated with an input shaft, a second rotatable target having a second sensor and associated with an output shaft, and a static multilayered support structure positioned intermediate the first and second rotatable targets. The static multilayered structure includes a first integrated circuit that is coupled to a first primary winding and first secondary winding(s), associated with the first rotatable target, and induces a first alternating signal to the first primary winding to generate a first magnetic field that induces a first voltage in the first secondary winding(s), and includes a second integrated circuit that is coupled to a second primary winding and second secondary winding(s), associated with the second rotatable target, and induces a second alternating signal to the second primary winding to generate a second magnetic field that induces a second voltage in the secondary winding(s).

### CROSS-REFERENCE TO RELATED APPLICATION

The present application claims priority from Indian Patent Application No. 202511030223, filed on Mar. 28, 2025, which is incorporated herein by reference in its entirety.

### TECHNICAL FIELD

The present disclosure relates generally to inductive position sensors, and more specifically to systems, apparatuses, and methods to provide differential angle position sensing using inductive position sensors.

### SUMMARY

According to an aspect of one or more examples, there is provided a system to provide differential angle position sensing using inductive position sensors. The system may include a first rotatable target associated with an input shaft, the first rotatable target comprising a first sensor, a second rotatable target associated with an output shaft, the second rotatable target comprising a second sensor, and a static multilayered support structure positioned intermediate to the first rotatable target and the second rotatable target. The static multilayered structure may include a first integrated circuit coupled to a first primary winding and one or more first secondary windings, the first integrated circuit being associated with the first rotatable target, the first integrated circuit to induce a first alternating signal to the first primary winding to generate a first magnetic field that induces a first voltage in the one or more first secondary windings, and a second integrated circuit coupled to a second primary winding and one or more second secondary windings, the second integrated circuit being associated with the second rotatable target, the second integrated circuit to induce a second alternating signal to the second primary winding to generate a second magnetic field that induces a second voltage in the one or more second secondary windings. At least one of the first rotatable target and the second rotatable target may include an inner ring to reduce interference between a first magnetic field associated with the first sensor and a second magnetic field associated with the second sensor.

The first integrated circuit may include circuitry to measure, based on the first voltage, angular position of the first rotatable target and the second integrated circuit may include circuitry to measure, based on the second voltage, angular position of the second rotatable target, the angular position of the first rotatable target corresponding to angular position of the input shaft and the angular position of the second rotatable target corresponding to angular position of the output shaft. The system may also include an input shaft coupled, via one or more gear mechanisms, to the first rotatable target and an output shaft coupled, via the one or more gear mechanisms, to the second rotatable target. The one or more gear mechanisms may include at least one torsion bar. The input shaft and output shaft may be associated with a rotatable steering mechanism for steering a vehicle.

The static multilayered support structure may be a two-layered printed circuit board that may include a top layer and a bottom layer, the top layer being separated by the bottom layer by a dielectric, the top layer and the bottom layer including a non-ferrous metal. The top layer may include the first primary winding and the one or more first secondary windings, and the bottom layer may include the second primary winding and the one or more second secondary windings. The dielectric may include a plurality of vias to electrically connect the top layer and the bottom layer. The first rotatable target and the second rotatable target may include non-ferrous material. The inner ring may include a plurality of fins radially extending from the inner ring and respective apertures positioned between fin edges of respective fins of the plurality of fins. The plurality of fins may include nine fins radially positioned 40° apart. The first primary winding may include a first circular winding pattern about an axis of rotation of the first rotatable target and the second rotatable target. The second primary winding may also include a second circular winding pattern about the axis of rotation of the first rotatable target and the second rotatable target, and the first primary winding may include a greater circumference than the second primary winding. The one or more second secondary winding may include sensory coils located between the first circular winding pattern of the first primary winding and the second circular winding pattern of the second primary winding. The one or more first secondary winding may include sensory coils located between the second circular winding pattern of the second primary winding and a center point of the second circular winding pattern, and the center point may include the axis of rotation. Further, rotation of the first rotatable target may be to produce a first feedback signal to the first integrated circuit that comprises a first set of modulated sine and cosine waveforms and rotation of the second rotatable target may be to produce a second feedback signal to the second integrated circuit that may include a second set of modulated sine and cosine waveforms. The first integrated circuit may be to demodulate the first set of modulated sine and cosine waveforms, and the second integrated circuit may be to demodulate the second set of modulated sine and cosine waveforms. The first integrated circuit and the second integrated circuit are to ascertain position information of the input shaft and the output shaft by performing an Arctan2 function.

The static multilayered support structure may include the first primary winding, the one or more first secondary windings, the second primary winding and the one or more second secondary windings. The one or more first secondary windings may include two secondary windings that are sinusoidal, and the one or more second secondary windings may include two additional secondary windings that are sinusoidal. Respective windings of the two secondary windings may be offset by a first angle of substantially Φ₁ degrees and the two additional secondary windings may be offset by a second angle of substantially Φ₂ degrees. The first sensor and the second sensor may be the inductive position sensors. The first integrated circuit may be to provide a first frequency signal of about 1 MHz to 6 MHz, and in one example embodiment may be about 5 MHz, to generate the first magnetic field and the second integrated circuit may be to provide a second frequency signal of about 1 MHz to 6 MHz, and in one example embodiment may be about 5 MHz, to generate the second magnetic field.

According to an aspect of one or more examples, there is provided an apparatus to provide differential angle position sensing using inductive position sensors. The apparatus may include a static multilayered support structure positioned intermediate to a first rotatable target and a second rotatable target. The static multilayered structure may include a first integrated circuit coupled to a first primary winding and one or more first secondary windings. The first integrated circuit may be associated with the first rotatable target, and the first integrated circuit may be to induce a first alternating signal to the first primary winding to generate a first magnetic field that induces a first voltage in the one or more first secondary windings. The static multilayered structure may also include a second integrated circuit coupled to a second primary winding and one or more second secondary windings. The second integrated circuit may be associated with the second rotatable target, and the second integrated circuit may be to induce a second alternating signal to the second primary winding to generate a second magnetic field that induces a second voltage in the one or more second secondary windings.

According to an aspect of one or more examples, there is provided a method to provide differential angle position sensing using inductive position sensors. The method may include inducing, via a first integrated circuit coupled to a first primary winding and one or more first secondary windings, a first alternating signal to the first primary winding to generate a first magnetic field that induces a first voltage in the one or more first secondary windings. The first integrated circuit may be associated with a first rotatable target associated with an input shaft, and the first rotatable target may include a first sensor. The method may also include inducing, via a second integrated circuit coupled to a second primary winding and one or more second secondary windings, a second alternating signal to the second primary winding to generate a second magnetic field that induces a second voltage in the one or more second secondary windings. The second integrated circuit may be associated with a second rotatable target associated with an output shaft, and the second rotatable target may include a second sensor. A static multilayered support structure positioned intermediate to the first rotatable target and the second rotatable target may include the first integrated circuit, the first primary winding, the one or more first secondary windings, the second integrated circuit, the second primary winding, and the one or more second secondary windings. At least one of the first rotatable target and the second rotatable target may include an inner ring to reduce interference between the first magnetic field associated with the first sensor and the second magnetic field associated with the second sensor.

### BRIEF DESCRIPTION OF DRAWINGS

FIG. 1A shows a perspective view of a system to provide differential angle position sensing using inductive position sensors, according to one or more examples.

FIG. 1B shows a side view of portions of the system of FIG. 1A, according to one or more examples.

FIG. 1C shows a top view of an apparatus of the system of FIG. 1A, according to one or more examples.

FIG. 1D shows a top view of the system of FIG. 1A, according to one or more examples.

FIG. 2 shows block diagrams associated with the system of FIG. 1A, according to one or more examples.

FIG. 3A shows a graph of measured signals produced from the system of FIG. 1A, according to one or more examples.

FIG. 3B shows a graph of measured signals produced from the system of FIG. 1A, according to one or more examples.

FIG. 4 shows a top view of an apparatus to provide differential angle position sensing using inductive position sensors, according to one or more examples.

FIG. 5 shows a flowchart illustrating a method to provide differential angle position sensing using inductive position sensors, according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be exemplified in various forms without being limited to the examples set forth herein.

Integrated circuits may include interconnections and various electrical components such as transistors, resistors, capacitors, and diodes that are incorporated into a semiconductor wafer. Integrated circuits may function as one or more of a microcontroller, microprocessor, amplifier, oscillator, timer, counter, logic gate, and computer memory. Integrated circuits may be utilized in position sensors for various real-world applications including automotive, industrial, and aerospace applications. The systems, apparatuses, and methods disclosed herein may utilize integrated circuits as part of a non-contacting planar inductive sensor to measure position of a movable target. In particular, such non-contacting planar inductive sensors may be used to measure angles between various shafts, such as an input shaft and an output shaft, of various automotive and industrial applications. For example, in the automotive context, differential angles may refer to the angles between an input shaft and an output shaft that allow the wheels on the same axle of a vehicle to rotate at different speeds while turning a corner. The non-contacting planar inductive sensor technology may be used to measure a radial position of a rotatable target relative a stationary sensor apparatus.

The systems, apparatuses, and methods disclosed herein may provide an advantage over existing technology in that a single static printed circuit board (PCB) may incorporate non-contacting planar inductive sensor technology to measure a radial position of both an input shaft target and an output shaft target in order to ascertain an input shaft position and an output shaft position for a gear train. The input shaft position and the output shaft position may be used to calculate the amount of torque being applied to the gear train in order to increase acceleration and movement of various automotive and industrial applications. In one example, the PCB may include two layers in order to reduce costs associated with PCB production. In particular, the two-layered PCB may include a top layer and a bottom layer, where the top layer may be separated by the bottom layer by a dielectric. Further, the top layer and the bottom layer may each include a non-ferrous metal.

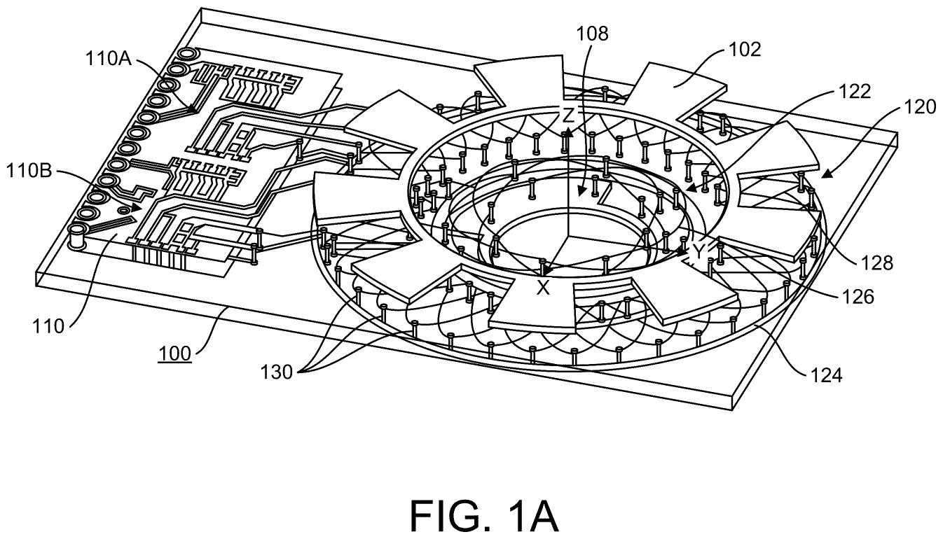

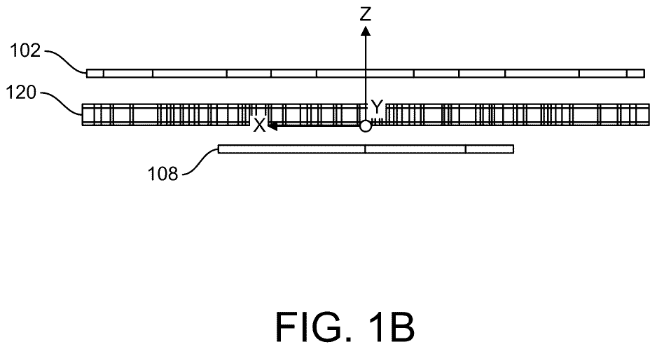

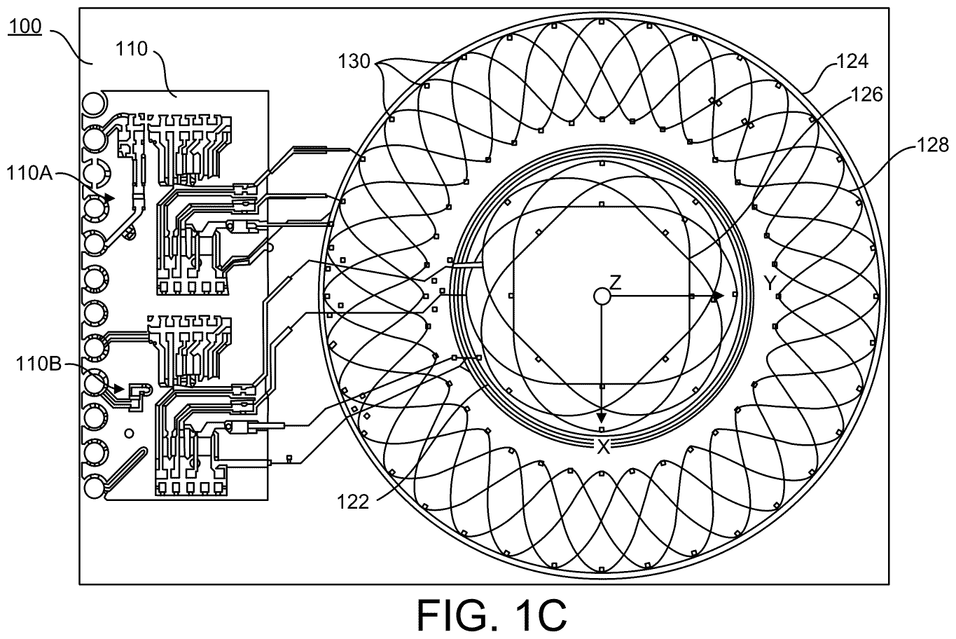

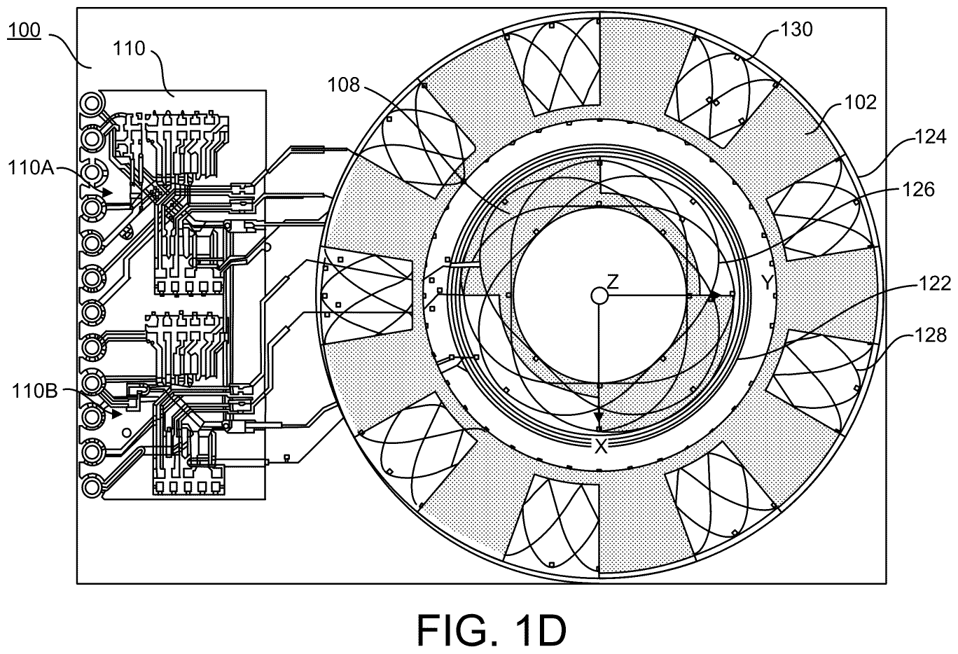

FIGS. 1A-1D show various views of a system and an apparatus 100 used by the system to provide differential angle position sensing using inductive position sensors, according to one or more examples. In particular, the system may include the apparatus 100 together with a first inductive position sensor that is also referred to herein as a first rotatable target 102 and a second inductive position sensor that is also referred to herein as a second rotatable target 108. The apparatus first rotatable target 102 and the second rotatable target 108 may include a conductive non-ferrous material such as metal or a metal alloy. In some examples, the non-ferrous material may include copper, aluminum, stainless steel, brass, or various other non-ferrous materials without limitation. In various examples, the first rotatable target 102 may be associated with an input shaft, and the second rotatable target 108 may be associated with an output shaft. Alternatively, depending upon the arrangement of the apparatus 100 relative to the input shaft and the output shaft, the first rotatable target 102 may be associated with the output shaft and the second rotatable target 108 may be associated with the input shaft. For example, the input shaft may be coupled, via one or more gear mechanisms, to the first rotatable target 102 and the output shaft may be coupled, via the one or more gear mechanisms, to the second rotatable target 108. In various examples, the one or more gear mechanisms may include at least one torsion bar. Further, the input shaft and the output shaft may be associated with rotating a steering mechanism for steering a vehicle.

The apparatus 100 may include a static multilayered support structure such as a PCB 120. The apparatus 100 may include a single shaft static PCB 120 positioned within the system intermediate to the first rotatable target 102 and the second rotatable target 108. In various examples, the multilayered PCB 120 may include a two-layered PCB 120 where the top layer may include a first primary winding 124 and one or more first secondary windings 128. Further, the bottom layer of the PCB 120 may include the second primary winding 122 and the one or more second secondary windings 126. The apparatus 100 may include integrated circuits 110 that are used to induce voltage across the one or more first secondary windings 128 and the one or more second secondary windings 126.

In various examples, a first integrated circuit 110A may be coupled to the first primary winding 124 and the one or more first secondary windings 128. The first integrated circuit 110A may induce a first voltage to the one or more first secondary windings. The first integrated circuit 110A may be associated with the first rotatable target 102. In various examples, the first integrated circuit 110A includes circuitry to measure, based on the first voltage, angular position of the first rotatable target 102 where the angular position of the first rotatable target 102 may correspond to angular position of the input shaft.

In various examples, the first rotatable target 102 may include an inner ring to reduce interference between a first magnetic field associated with the first rotatable target 102, which may include the first sensor, and a second magnetic field associated with a second rotatable target 108. The first magnetic field may be associated with an alternating current. The first integrated circuit 110A may include an oscillator or other excitation circuitry that may be coupled to a first primary winding 124. The first integrated circuit 110A may generate an alternating excitation signal within a certain range of frequencies (e.g., 1-6 MHz, without limitation), which induces the first voltage that is used to measure angular position of the first rotatable target 102, to generate the first magnetic field. Further, the first integrated circuit 110A may couple to two secondary coils of the one or more first secondary windings 128 and the magnetic field that is generated induces a first voltage in the one or more first secondary windings 128. The first integrated circuit 110A may also include position sensor circuitry to process signals associated with the first voltage. In various examples, the first primary windings 124 may be excited with a relatively high frequency signal using the first integrated circuit 110A to generate the first magnetic field. For example, the first integrated circuit 110A may provide a first frequency signal of about 1-6 MHz or more particularly about 5 MHz to generate the first magnetic field. The first magnetic field may be used to produce sinusoidal signals. The first rotatable target 102 may be rotated, which may cause the first magnetic field to be disturbed, which creates modulated sinusoidal signals. In examples in which the one or more first secondary windings 128 include two secondary windings, the two secondary windings receive different voltages relative to the position of the first rotatable target 102. The modulated sinusoidal signals may be in the form of sine and cosine waveforms, which are provided as feedback signals back to the first integrated circuit 110A.

The two secondary windings may include first sensory coils and second sensory coils that are arranged in a sinusoidal configuration and offset one winding from another by a first angle of substantially Φ₁ degrees. In various examples, the coils of both of the two secondary windings may be multifunctional in order to provide oscillating signals that also detect changes in the first magnetic field such that the coils of the two secondary windings act as sensory coils. The two secondary windings of the one or more first secondary windings 128 may be located within the PCB 120 and positioned to encircle an axis of rotation, labeled “Z” in FIGS. 1A-1D, of the first rotatable target 102 at a distance from the axis of rotation “Z” that is in between the first circular winding pattern of the first primary winding 124 and the second circular winding pattern of the second primary winding 122. More particularly, the one or more first secondary windings 128 may be positioned between the inner ring of the first rotatable target 102 and the first primary winding 124, which enables the inner ring of the first rotatable target 102 to reduce interference between a first magnetic field associated with the first rotatable target 102 and the second magnetic field associated with a second rotatable target 108. The inner ring of the first rotatable target 102 may include one or more fins radially extending from the inner ring and respective apertures positioned between fin edges of respective fins of the plurality of fins. The fins may be selectively positioned based on a particular use case. For example, as depicted by FIGS. 1A and 1D, the plurality of fins may include nine fins radially positioned 40° apart. Alternatively, various other examples may include one or more fins radially positioned at equidistant angles one from another around the inner ring. The position of the plurality of fins may be application dependent based on measurement range requirement.

The first primary winding 124 may include a first circular winding pattern that encircles the axis of rotation “Z” of the first rotatable target 102 and the second rotatable target 108. The second primary winding 122 may also include a second circular winding pattern that encircles the axis of rotation “Z” of the first rotatable target 102 and the second rotatable target 108. The second primary winding 122 may include a smaller circumference than the first primary winding 124.

In various examples, the second rotatable target 108 may also include an inner ring with one or more fins radially positioned at equidistant angles one from another. For example, as depicted by FIGS. 1A and 1D, the one or more fins may include two fins radially positioned 180° apart. The inner ring of the second rotatable target 108 may encircle the axis of rotation “Z” that serves as the axis of rotation for both the first rotatable target 102 and the second rotatable target 108. The circumference of the outer edge of the one or more fins of the second rotatable target may be less than the inner circumference of the inner ring of the first rotatable target 102.

In various examples, a second integrated circuit 110B may be coupled to the second primary winding 122 and one or more second secondary windings 126. Further, the second integrated circuit 110B may be associated with the second rotatable target 108, which may serve as a second inductive position sensor that is associated with a second magnetic field, and the second integrated circuit 110B may induce a second voltage to the one or more secondary windings 126. The second integrated circuit 110B may provide a second frequency signal of about 5 MHz to generate the second magnetic field. In particular, the one or more second secondary windings 126 may be excited with a relatively high frequency signal using the second integrated circuit 110B to generate the second magnetic field. The second magnetic field may include an alternating current. The second integrated circuit 110B may include an oscillator or other excitation circuitry that may generate an excitation signal within a certain range of frequencies (e.g., 1-6 MHz, without limitation), which induces the second voltage that is used to measure angular position of the second rotatable target 108. The second integrated circuit 110B includes circuitry to measure, based on the second voltage, angular position of the second rotatable target 108, and the angular position of the second rotatable target 108 may correspond to angular position of the output shaft.

The second magnetic field may couple to two secondary coils of the one or more second secondary windings 126 to generate the second voltage. The second integrated circuit 110B may also include position sensor circuitry to process signals associated with the second voltage. The second magnetic field may be used to produce sinusoidal signals. The second rotatable target 108 may be rotated, which may cause the second magnetic field to be disturbed, which creates modulated sinusoidal signals. In examples in which the one or more second secondary windings 126 include two secondary windings, the two secondary windings receive different voltages relative to the position of the first rotatable target 108. In various examples, the one or more second secondary windings 126 may include two secondary windings that are arranged in a sinusoidal configuration. The modulated sinusoidal signals may be in the form of sine and cosine waveforms, which are provided as feedback signals back to the second integrated circuit 110B. The two secondary windings may include first sensory coils and second sensory coils that are arranged sinusoidally and offset one winding from another by a second angle of substantially Φ₂ degrees. In various examples, the coils of both of the two secondary windings may be multifunctional in order to provide oscillating signals that also detect changes in the first magnetic field such that the coils of the two secondary windings act as sensory coils. The one or more second secondary winding 126 may include the two secondary windings that are located between the second circular winding pattern of the second primary winding 122 and a center point of the second circular winding pattern, where the center point serves as the axis of rotation “Z” of both the first rotatable target 102 and the second rotatable target 108.

The static multilayered support structure of the apparatus 100 may include the first primary winding 124, the one or more first secondary windings 128, the second primary winding 122 and the one or more second secondary windings 126 as well as the first integrated circuit 110A and the second integrated circuit 110B. The static multilayered support structure may include a two-layered PCB 120. The two-layered PCB 120 may include a top layer and a bottom layer, where the top layer may be separated by the bottom layer by a dielectric. The dielectric may include a plurality of vias 130 to electrically connect the top layer and the bottom layer.

In various examples, rotation of the first rotatable target 102 produces a first feedback signal to the first integrated circuit 110A. The first feedback signal may include a first set of modulated sine and cosine waveforms. In addition, rotation of the second rotatable target 108 produces a second feedback signal to the second integrated circuit 110B. The second feedback signal may include a second set of modulated sine and cosine waveforms. The first integrated circuit 110A may demodulate the first set of modulated sine and cosine waveforms and the second integrated circuit 110B may demodulate the second set of modulated sine and cosine waveforms. Further, the first integrated circuit 110A uses the first set of demodulated sine and cosine waveforms and the second integrated circuit 110B uses the second set of demodulated sine and cosine waveforms to ascertain position information of the input shaft and the output shaft by performing an Arctan2 function. Depending upon the arrangement of the apparatus 100 relative the input shaft and the output shaft, in various examples the first integrated circuit 110A may ascertain the position of the input shaft and the second integrated circuit 110B may ascertain the position of the output shaft. In other examples, the first integrated circuit 110A may ascertain the position of the output shaft and the second integrated circuit 110B may ascertain the position of the input shaft.

The first rotatable target 102 and the second rotatable target 108 may be generally planar in shape and define a circular fan shape. The number of fins for the first rotatable target 102 and the second rotatable target 108 may be equal to “N” with an angle of Φ degrees (where Φ=360°/N). Thus, the fins of the first rotatable target 102 may be positioned at Φ₁ degrees and the fins of the second rotatable target 108 may be positioned at Φ₂ degrees. Further, the first and second coils of the one or more first secondary windings 128 or the one or more second secondary windings 126 may be mechanically positioned offset one from another by an angle of Φ₁ degrees and Φ₂ degrees, respectively. The mechanical positioning for the phase shift of the first and second coils translates to first and second sinusoidal signals.

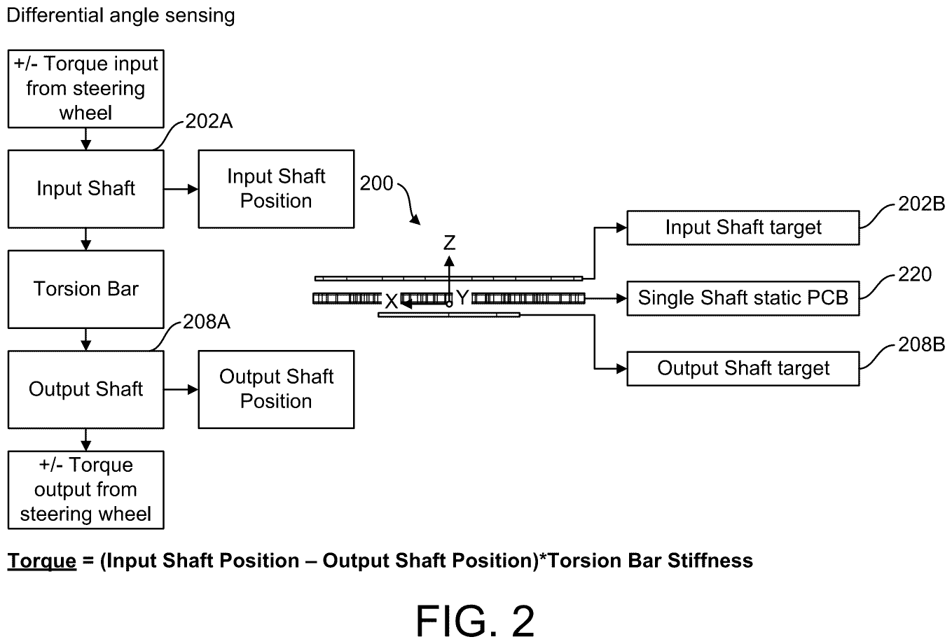

With reference to FIG. 2, an apparatus 200 is depicted in which a positive or negative torque input from a gear mechanism such as a gear train may result, in an example use case of a vehicle, from turning a steering wheel. This may alter the position of the input shaft 202A associated with the input shaft target 202B. The torque may be measured through differential angle sensing from the input shaft 202A to the output shaft 208A, where the output shaft 208A is associated with the output shaft target 208B multiplied by the torsion bar stiffness. The torsion bar stiffness may be calculated by multiplying the cross-sectional shape of the torsion bar by the material's shear modulus (meaning the modulus of rigidity of the material), divided by the length of the torsion bar. The change in position of the output shaft 208A may lead to a positive or negative torque output to the gear mechanism. The static multilayered support structure may be represented as a single shaft static PCB 220 and is used as a differential angle position sensor with integrated circuits such as those described herein to induce voltage, demodulate the modulated sine and cosine waveforms that result from rotation of the input shaft target 202B and the output shaft target 208B to ascertain position information of the input shaft 202A and the output shaft 208A.

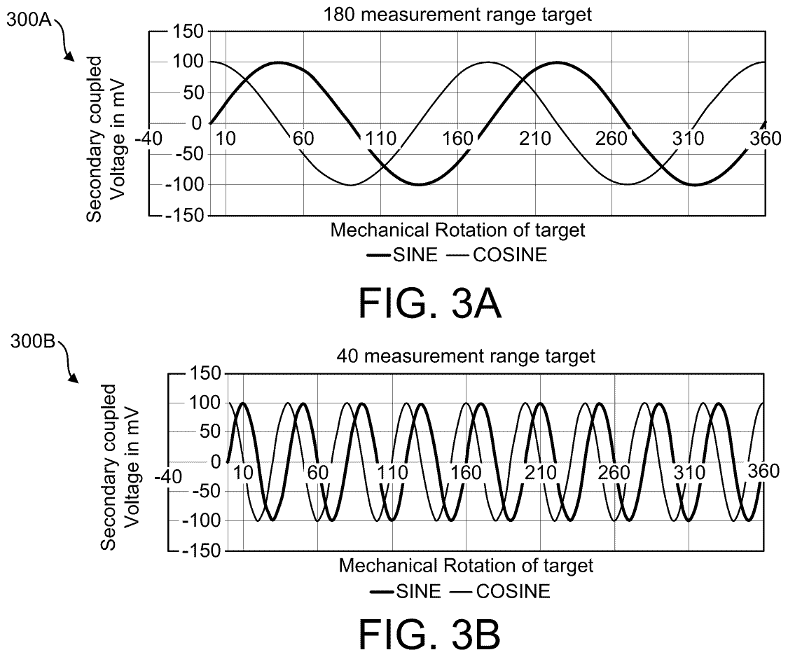

FIGS. 3A and 3B depict sine and cosine waveforms produced from the mechanical rotation of rotatable targets. As non-limiting examples, a 180-measurement range target 300A and a 40-measurement range target 300B are depicted. When a rotatable target rotates, it creates modulated sine and cosine waveforms, which are provided as feedback signals back to the associated integrated circuit that the integrated circuit then demodulates in order to calculate position information. Specifically, the arctan2 function of the two signals produced from the sine and cosine waveforms are used to determine the position information. Because the apparatus includes two targets, there may be two distinct measurements that are different due to the difference in the angular fin positioning of the target. The targets may have differing quantities of fins based on the specific use case application. In various examples, one target may have an even number of fins whereas another target may have an odd number of fins, which provides one even and one odd pole pair design combination.

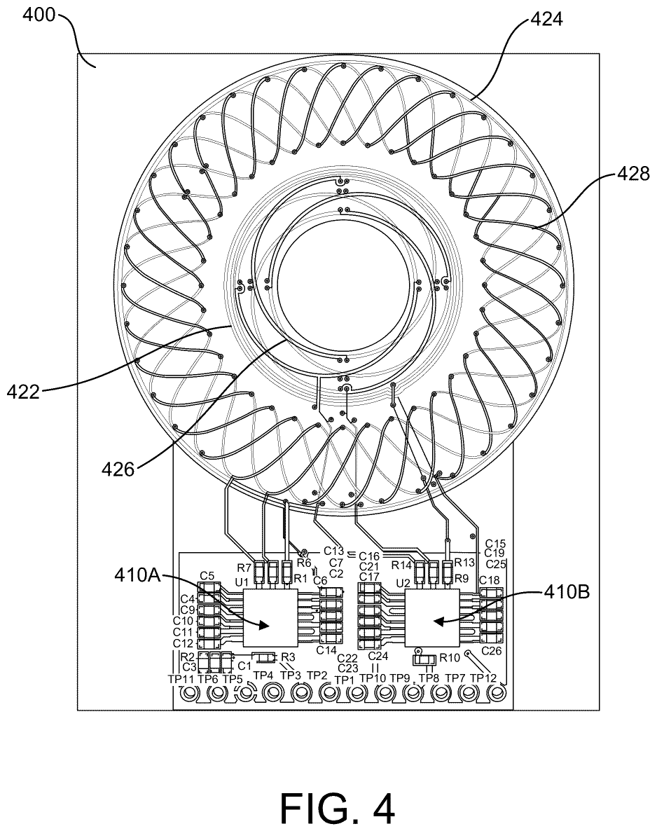

FIG. 4 shows a top view of an apparatus 400 to provide differential angle position sensing using inductive position sensors, according to one or more examples. The apparatus 400 may include a static multilayered support structure that includes a first integrated circuit 410A and a second integrated circuit 410B. The first integrated circuit 410A may be coupled to a first primary winding 424 and one or more first secondary windings 428, where the first integrated circuit being associated with a first rotatable target. The first integrated circuit 410A may induce a first voltage to the one or more first secondary windings 428. The second integrated circuit 410B may be coupled to a second primary winding 422 and one or more second secondary windings 426. The second integrated circuit 410B may be associated with a second rotatable target. The second integrated circuit 410B may induce a second voltage to the one or more second secondary windings 426.

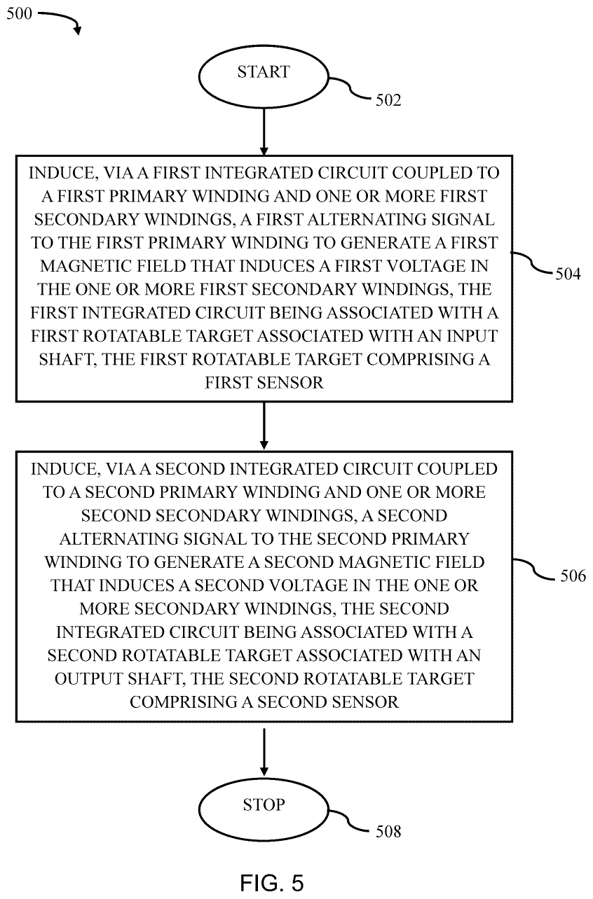

FIG. 5 shows a flowchart 500 illustrating a method to provide differential angle position sensing using inductive position sensors, according to one or more examples. It may be noted that in order to explain the flowchart, references will be made to elements explained in reference to FIGS. 1A-4. The flowchart 500 starts at operation 502. At operation 504, the method may include inducing, via a first integrated circuit 110A, 410A coupled to a first primary winding 124, 424 and one or more first secondary windings 128, 428, a first alternating signal to the first primary winding 124, 424 to generate a first magnetic field that induces a second voltage in the one or more first secondary windings 128, 428, where the first integrated circuit 110A, 410A may be associated with a first rotatable target 102, 202B associated with an input shaft 202A, and the first rotatable target 102, 202B may include a first sensor.

At operation 506, the method may include inducing, via a second integrated circuit 110B, 410B coupled to a second primary winding 122, 422 and one or more second secondary windings 126, 426, a second alternating signal to the second primary winding 122, 422 to generate a second magnetic field that induces a second voltage in the one or more second secondary windings 126, 426. The second integrated circuit 110B, 410B may be associated with a second rotatable target 108, 208B associated with an output shaft 208, and the second rotatable target 108, 208B may include a second sensor. Further, a static multilayered support structure, such as an apparatus 100, 400, positioned intermediate to the first rotatable target 102, 202B and the second rotatable target 108, 208B may include the first integrated circuit 110A, 410A, the first primary winding 124, 424, the one or more first secondary windings 128, 428, the second integrated circuit 110B, 410B, the second primary winding 122, 422, and the one or more second secondary windings 126, 426. In addition, at least one target of the first rotatable target 102, 202B and the second rotatable target 108, 208B includes an inner ring to reduce interference between the first magnetic field associated with the first sensor and the second magnetic field associated with the second sensor. At operation 508, the method may stop.

Various examples have been disclosed herein, in connection with the above description and the drawings. It will be understood that it would be unduly repetitious to literally describe and illustrate all possible combinations or subcombinations of these examples. Accordingly, all examples can be combined in any way or combination, without limitation, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, the accompanying drawings are not to scale. A variety of modifications and variations are possible in light of the above teachings.

What is claimed is:

1. A system to provide differential angle position sensing using inductive position sensors, the system comprising:
a first rotatable target associated with an input shaft, the first rotatable target comprising a first sensor;
a second rotatable target associated with an output shaft, the second rotatable target comprising a second sensor;
a static multilayered support structure positioned intermediate to the first rotatable target and the second rotatable target, the static multilayered structure comprising:
a first integrated circuit coupled to a first primary winding and one or more first secondary windings, the first integrated circuit being associated with the first rotatable target, the first integrated circuit to induce a first alternating signal to the first primary winding to generate a first magnetic field that induces a first voltage in the one or more first secondary windings; and
a second integrated circuit coupled to a second primary winding and one or more second secondary windings, the second integrated circuit being associated with the second rotatable target, the second integrated circuit to induce a second alternating signal to the second primary winding to generate a second magnetic field that induces a second voltage in the one or more second secondary windings;
wherein at least one of the first rotatable target and the second rotatable target includes an inner ring to reduce interference between a first magnetic field associated with the first sensor and a second magnetic field associated with the second sensor.

2. The system of claim 1, wherein the first integrated circuit includes circuitry to measure, based on the first voltage, angular position of the first rotatable target and the second integrated circuit includes circuitry to measure, based on the second voltage, angular position of the second rotatable target, the angular position of the first rotatable target corresponding to angular position of the input shaft and the angular position of the second rotatable target corresponding to angular position of the output shaft.

3. The system of claim 1, wherein the input shaft is coupled, via one or more gear mechanisms, to the first rotatable target and the output shaft is coupled, via the one or more gear mechanisms, to the second rotatable target.

4. The system of claim 3, wherein the one or more gear mechanisms include at least one torsion bar.

5. The system of claim 1, wherein the input shaft and output shaft are associated with a rotatable steering mechanism for steering a vehicle.

6. The system of claim 1, wherein the static multilayered support structure is a two-layered printed circuit board comprising a top layer and a bottom layer, the top layer being separated by the bottom layer by a dielectric, the top layer and the bottom layer comprising a non-ferrous metal.

7. The system of claim 6, wherein the top layer comprises the first primary winding and the one or more first secondary windings, and the bottom layer comprises the second primary winding and the one or more second secondary windings, wherein the dielectric includes a plurality of vias to electrically connect the top layer and the bottom layer.

8. The system of claim 1, wherein the first rotatable target and the second rotatable target comprise non-ferrous material.

9. The system of claim 1, wherein the inner ring includes a plurality of fins radially extending from the inner ring and respective apertures positioned between fin edges of respective fins of the plurality of fins.

10. The system of claim 9, wherein the plurality of fins comprise nine fins radially positioned 40° apart.

11. The system of claim 1, wherein the first primary winding comprises a first circular winding pattern about an axis of rotation of the first rotatable target and the second rotatable target, wherein the second primary winding also comprises a second circular winding pattern about the axis of rotation of the first rotatable target and the second rotatable target, the first primary winding comprising a greater circumference than the first primary winding.

12. The system of claim 11, wherein the one or more second secondary winding comprises second sensory coils located between the first circular winding pattern of the first primary winding and the second circular winding pattern of the second primary winding, and wherein the one or more first secondary winding comprises first sensory coils located between the second circular winding pattern of the second primary winding and a center point of the second circular winding pattern, the center point comprising the axis of rotation.

13. The system of claim 1, wherein rotation of the first rotatable target is to produce a first feedback signal to the first integrated circuit that comprises a first set of modulated sine and cosine waveforms and wherein rotation of the second rotatable target is to produce a second feedback signal to the second integrated circuit that comprises a second set of modulated sine and cosine waveforms, wherein the first integrated circuit is to demodulate the first set of modulated sine and cosine waveforms and the second integrated circuit is to demodulate the second set of modulated sine and cosine waveforms, wherein the first integrated circuit and the second integrated circuit are to ascertain position information of the input shaft and the output shaft by performing an Arctan2 function.

14. The system of claim 1, wherein the static multilayered support structure comprises the first primary winding, the one or more first secondary windings, the second primary winding and the one or more second secondary windings.

15. The system of claim 1, wherein the one or more first secondary windings comprise two secondary windings that are sinusoidal and the one or more second secondary windings comprise two additional secondary windings that are sinusoidal.

16. The system of claim 15, wherein respective windings of the two secondary windings are offset by a first angle of substantially Φ₁ degrees and the two additional secondary windings are offset by a second angle of substantially Φ₂ degrees.

17. The system of claim 1, wherein the first sensor and the second sensor are the inductive position sensors.

18. The system of claim 1, wherein the first integrated circuit is to provide a first frequency signal of about 1 MHz to about 6 MHz to generate the first magnetic field and the second integrated circuit is to provide a second frequency signal of about 1 MHz to about 6 MHz to generate the second magnetic field.

19. An apparatus to provide differential angle position sensing using inductive position sensors, the apparatus comprising:
a static multilayered support structure positioned intermediate to a first rotatable target and a second rotatable target, the static multilayered structure comprising:
a first integrated circuit coupled to a first primary winding and one or more first secondary windings, the first integrated circuit being associated with the first rotatable target, the first integrated circuit to induce a first alternating signal to the first primary winding to generate a first magnetic field that induces a first voltage in the one or more first secondary windings; and
a second integrated circuit coupled to a second primary winding and one or more second secondary windings, the second integrated circuit being associated with the second rotatable target, the second integrated circuit to induce a second alternating signal to the second primary winding to generate a second magnetic field that induces a second voltage in the one or more second secondary windings.

20. A method to provide differential angle position sensing using inductive position sensors, the method comprising:
inducing, via a first integrated circuit coupled to a first primary winding and one or more first secondary windings, a first alternating signal to the first primary winding to generate a first magnetic field that induces a first voltage in the one or more first secondary windings, the first integrated circuit being associated with a first rotatable target associated with an input shaft, the first rotatable target comprising a first sensor; and
inducing, via a second integrated circuit coupled to a second primary winding and one or more second secondary windings, a second alternating signal to the second primary winding to generate a second magnetic field that induces a second voltage in the one or more second secondary windings, the second integrated circuit being associated with a second rotatable target associated with an output shaft, the second rotatable target comprising a second sensor;
wherein a static multilayered support structure positioned intermediate to the first rotatable target and the second rotatable target comprises the first integrated circuit, the first primary winding, the one or more first secondary windings, the second integrated circuit, the second primary winding, and the one or more second secondary windings;
wherein at least one of the first rotatable target and the second rotatable target includes an inner ring to reduce interference between the first magnetic field associated with the first sensor and the second magnetic field associated with the second sensor.
